(19) United States
(12) Patent Application Publication
(10) Pub. No.: US 2011/0096066 A1
(43) Pub. Date: Apr. 28, 2011

(54) Active Matrix Displays

(75) Inventors: Barry Thompson, Menlo Park, CA (US); Euan Smith, Cambridgeshire (GB)

(73) Assignee: CAMBRIDGE DISPLAY TECHNOLOGY LIMITED

(21) Appl. No.: 12/991,334

(22) PCT Filed: Mar. 31, 2009
(86) PCT No.: PCT/GB09/00866

§ 371 Date: Dec. 21, 2010

(30) Foreign Application Priority Data
May 7, 2008 (GB) 0808178.8

(51) Int. Cl. G09G 3/32; G09G 5/00

(52) U.S. Cl. 345/212; 345/76

(57) ABSTRACT

An active matrix OLED display (200) comprising a data line (202), a plurality of pixel circuits (203) connected to the data line (202), a drive circuit (201) connected towards one end of the data line (202) for writing display data to the pixel circuits (203), and a programmable drive boost circuit (204) connected towards another end of the data line (202) from the drive circuit (201).

This invention generally relates to active matrix displays and to related display driving methods. More particularly the invention relates to additional driving circuitry for active matrix driven Organic Light Emitting Diode (OLED) displays employed to improve the performance characteristics of the device.

Displays fabricated using OLEDs provide a number of advantages over LCD and other flat panel technologies. They are bright, colourful, fast-switching (compared to LCDs), provide a wide viewing angle and are easy and cheap to fabricate on a variety of substrates. Organic (which here includes organometallic) LEDs may be fabricated using materials including polymers, small molecules and dendrimers, in a range of colours which depend upon the materials employed. Examples of polymer-based organic LEDs are described in WO 90/13148, WO 95/06400 and WO 99/48160; examples of dendrimer-based materials are described in WO 99/21935 and WO 02/067343; and examples of so called small molecule based devices are described in U.S. Pat. No. 4,539,507.

A typical OLED device comprises two layers of organic material, one of which is a layer of light emitting material such as a light emitting polymer (LEP), oligomer or a light emitting low molecular weight material, and the other of which is a layer of a hole transporting material such as a polythiophene derivative or a polyaniline derivative.

Organic LEDs may be deposited on a substrate in a matrix of pixels to form a single or multi-colour pixellated display. A multicoloured display may be constructed using groups of red, green, and blue emitting pixels. So-called active matrix (AM) displays have a memory element, typically a storage capacitor and a transistor, associated with each pixel whilst passive matrix displays have no such memory element and instead are repetitively scanned to give the impression of a steady image. Examples of polymer and small-molecule active matrix display drivers can be found in WO 99/42983 and EP 0,717,446A respectively.

A display may be either bottom-emitting or top-emitting. In a bottom-emitting display light is emitted through the substrate on which the active matrix circuitry is fabricated; in a top-emitting display light is emitted towards a front face of the display without having to pass through a layer of the display in which the active matrix circuitry is fabricated.

Top-emitting OLED displays are less common than bottom-emitting displays because, typically, the upper electrode comprises the cathode and this must be at least partially transparent, as well as having sufficient conductivity and, preferably, providing a degree of encapsulation of the underlying organic layers. Nonetheless a large variety of top-emitting structures has been described, including in the applicant's published PCT application WO 2005/071771 (hereby incorporated by reference in its entirety) which describes a cathode incorporating an optical interference structure to enhance the amount of light escaping from the OLED pixel.

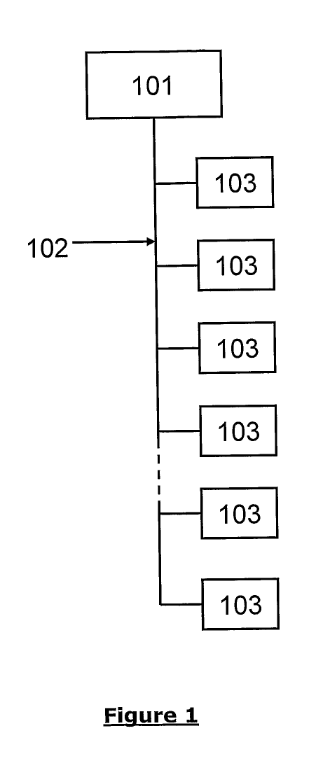

An OLED display conventionally displays an image built from a rectilinear matrix of picture elements (or pixels). An Active Matrix OLED display conventionally has a row data line and a column data line for each colour of each pixel. One such data line 102 is shown in FIG. 1. Referring to FIG. 1, a drive circuit 101 is connected to the data line 102 which is connected to a plurality of pixel circuits 103. Each pixel circuit 103 corresponds to one pixel display element and contains a memory element (not shown). Each data line 102 will typically be connected to many hundred pixel circuits 103.

Within an active matrix OLED display, the data lines 102 utilise either a voltage driving method or a current driving method. The present state of the art enjoys increases in electrical efficiency when using current driving methods over voltage driving methods. Where the current driving method is used, the pixel circuits 103 may be used as either a current source or a current sink.

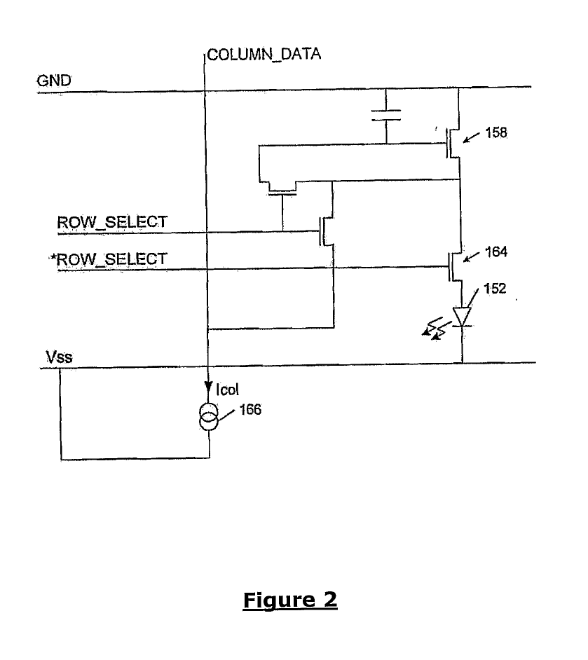

FIG. 2, which is taken from our application WO 03/038790, shows an example of a current-controlled pixel driver circuit. In this circuit the current through an OLED 152 is set by setting a drain source current for OLED driver transistor 158 using a reference current sink 166 and memorising the driver transistor gate voltage required for this drain-source current. Thus the brightness of OLED 152 is determined by the current, Icol, flowing into reference current sink 166, which is preferably adjustable and set as desired for the pixel being addressed. In addition, a further switching transistor 164 is connected between drive transistor 158 and OLED 152. In general one current sink 166 is provided for each column data line.

A problem shared by current driven active matrix pixel circuits is that where, as is often the case, the pixel “programming” currents are small leakage and/or data line capacitance may dominate, particularly in large displays.

As best seen in FIG. 1, conventional current-driven active matrix OLED displays must overcome the resistor-capacitor constant of the data line 102. The drive circuit 101 must overcome the inherent resistance and capacitance of the data line 102 in addition to supplying sufficient current to the pixel circuits 103 to achieve the desired light output.

According to a first aspect of the present invention, there is provided an active matrix OLED display comprising a data line, a plurality of pixel circuits connected to the data line, a drive circuit connected towards one end of the data line for writing display data to the pixel circuits, and a programmable drive boost circuit connected towards another end of the data line from the drive circuit.

The invention preferably provides a programmable drive boost circuit connected to the data line at an opposite end to which the drive circuit is connected. The addition of such a circuit enables a more rapid pre-charging of the active matrix OLED data line. As will be appreciated by a person skilled in the art, the programmable drive boost circuit can be a voltage controlled circuit or a current controlled circuit.

Preferably, the programmable drive boost circuit is a current source or current sink. Using the programmable drive boost circuit as a current source or current sink reduces the current required to overcome the resistor-capacitor coefficient of the data line. The benefits of the present invention include increased device power efficiency and lower time to display an image and consequential higher image display refresh rates.

Preferably, the programmable drive boost circuit comprises a select or enable circuit. More preferably, the drive circuit is connected to the enable circuit by a data bus. This allows the drive circuit to control the programmable drive boost circuit by transmitting an enable data bit and/or one or more program data bits.

Preferably, the programmable drive boost circuit is a current copier. Optionally, the current copier can be controlled as a variable current sink with a duty programmed enable signal or by a most significant bit of a programmed data signal or the copier can be enabled for a fixed period of time.

The programmable drive boost circuit can be n-channel or a p-channel depending upon circuit design requirements.

Preferably, the programmable drive boost circuit and the drive circuit are located on the same substrate. A suitable substrate or backplane can be one fabricated from amorphous silicon (a-Si).

According to a second aspect of the present invention, there is provided a method of programming an active matrix OLED display, the OLED display having a current programmed data line, a plurality of pixel circuits connected to the data line, a drive circuit connected towards one end of the data line to write display data to the pixel circuits, and a programmable drive boost circuit connected towards another end of the data line from the drive circuit; the method comprising a first addressing period including programming the programmable drive boost circuit with a first current; and a second addressing period including writing display data to the pixels and supplying the first current to the data line.

In this way, a current is programmed onto the data line by the programmable booster circuit. This method substantially reduces the charge time and charging the data line from both ends reduces the resistor-capacitor constant by around 75%.

Preferably, the method of programming comprises, in the first addressing period activating the programmable drive boost circuit with an enable data bit and one or more program data bits to provide a current biased with respect to the current provided to the data line from the drive circuit.

Preferably, the first addressing period comprises the programmable drive boost circuit being enabled for a fixed time period. Such an arrangement provides the benefits of the programmable booster circuit while avoiding the inefficiency of continuous use of the programmable booster circuit.

Preferably, the first addressing period comprises the programmable drive boost circuit being enabled and providing a current corresponding to the most significant bit of the digital signal information transmitted by the driver circuit. In such an arrangement, the maximum current provided by the programmable booster circuit and the drive circuits is reduced.

Preferably also, the first addressing period comprises the programmable booster circuit being programmed to vary according to a duty cycle. In such an arrangement the duty cycle may be selected, for example to overcome physical impurities in the material of the data line, to achieve an optimal display time or electrical efficiency, for example dependant upon the information content of the image to be displayed, or to follow a fixed duty cycle, for example to minimise the numerical calculations required to achieve the desired image display.

Embodiments of the present invention will now be further described, by way of example only, with reference to the accompanying drawings in which:

FIG. 1 is a schematic diagram of a row or column display layout as is known in the art;

FIG. 2 is a schematic diagram of an active matrix pixel driver circuit as is known in the art;

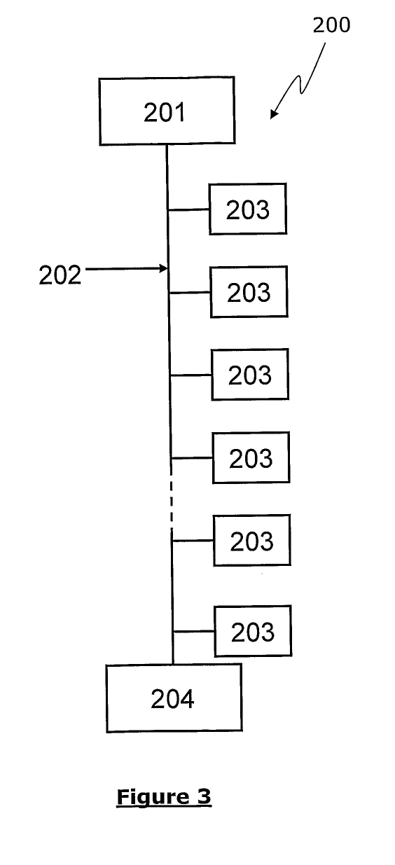

FIG. 3 is a schematic diagram of a row or column display layout according to an embodiment of the present invention; and

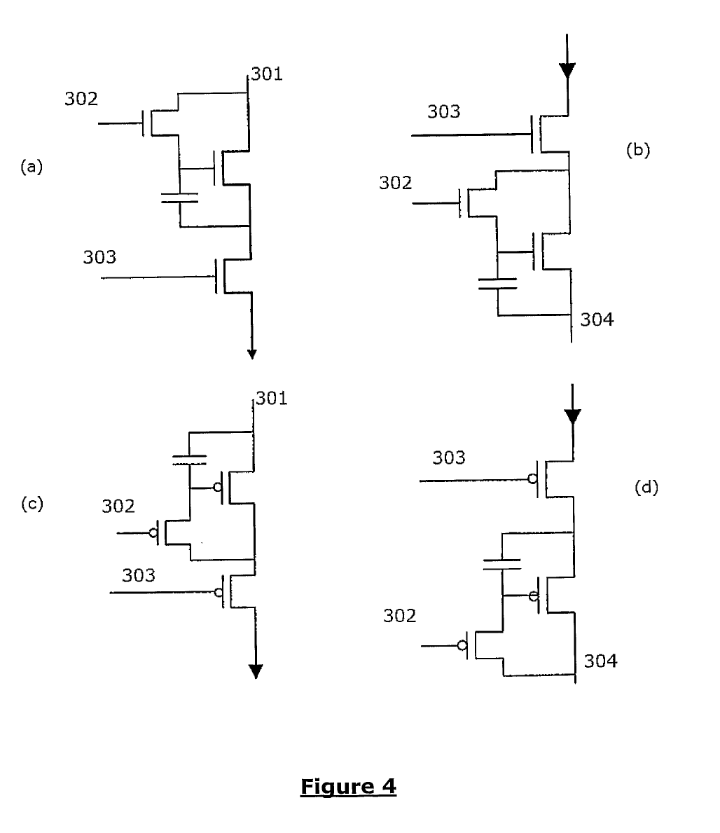

FIGS. 4a to 4d are schematic diagrams of four sample circuits for use as a programmable circuit booster circuit according to an embodiment of the present invention.

Referring to FIG. 3, a schematic diagram of a row or column display layout according to an embodiment of the present invention comprises an active matrix OLED display 200. The display 200 comprises a programmable booster circuit, showing drive chip circuit 201, data line 202, pixel circuits 203 and programmable drive boost circuit 204.

The programming of the display 200 has two stages due to the active matrix arrangement of the pixel circuits 203. In a first stage, drive circuit 201 identifies from the digital signal information the required current or range of current to be supplied to the pixel circuits 203 and supplies current to a plurality of pixel circuits 203 which store current in memory cells (not shown). Additionally, programmable booster circuit 204 is engaged during this first stage of programming. In a second stage, the drive circuit 201 ceases to supply current and the pixel circuits 203 drive an OLED (not shown) within the pixel circuit to illuminate a portion of the intended display image corresponding to the digital signal data supplied. In this arrangement, the drive circuit 201 is assisted by the programmable drive boost circuit 204 in the task of supplying current to charge the memory cells of the pixel circuits 203 and also to supply enough current to overcome the resistor-capacitor constant of the data line 202.

The programmable drive boost circuit 204 can function as a current copier in cooperation with the drive circuit 201 wherein both circuits 201, 204 source or sink current to the pixel circuits 203. Alternatively, the programmable booster circuit 204 may function in opposition to the drive circuit 201, wherein the programmable booster circuit 204 sinks current while the drive circuit 201 sources current or the programmable booster circuit 204 sources current while the drive circuit 201 sinks current.

The programmable booster circuit 204 can be enabled only during a pre-charge portion of the first stage of programming the display 200. Additionally, the programmable drive boost circuit 204 can be programmed to a level of current associated with the most significant bit of the digital signal information against which fixed level the drive circuit 201 programs the pixel circuits 203 during a first stage of programming the display 200. Additionally, the programmable drive boost circuit 204 can be programmed to follow a variable duty program, for example to optimise the current delivered according to the content of the intended display image.

FIGS. 4a to 4d are schematic diagrams of four sample circuits for use as a programmable circuit booster circuit 204 according to an embodiment of the present invention. Common in parts (a), (b), (c) and (d) of FIG. 4 are voltage source V_{DD} 301, program data 302, enable data 303 and circuit ground 304.

FIG. 4(a) shows a typical layout for an example programmable booster circuit 204 using n-type transistors to provide a current source programmable booster circuit.

FIG. 4(b) shows a typical layout for an example programmable booster circuit 204 using n-type transistors to provide a current sink programmable booster circuit.

FIG. 4(c) shows a typical layout for an example programmable booster circuit 204 using p-type transistors to provide a current source programmable booster circuit.

FIG. 4(d) shows a typical layout for an example programmable booster circuit using p-type transistors to provide a current sink programmable booster circuit.

No doubt other effective alternative will occur to the skilled person. It will be understood that the invention is not limited to the described embodiments and encompasses modifications apparent to those skilled in the art lying within the spirit and scope of the claims appended hereto.

1. An active matrix organic light-emitting diode (OLED) display comprising a data line, a plurality of pixel circuits connected to the data line, a drive circuit connected towards one end of the data line for writing display data to the pixel circuits, and a programmable drive boost circuit connected towards another end of the data line from the drive circuit.

2. An active matrix OLED display as claimed in claim 1, wherein the programmable drive boost circuit is connected to the data line at an opposite end to which the drive circuit is connected.

3. An active matrix OLED display as claimed in claim 1, wherein the programmable drive boost circuit is a current source or current sink.

4. An active matrix OLED display as claimed in claim 1, wherein the programmable drive boost circuit comprises a select or enable circuit.

5. An active matrix OLED display as claimed in claim 4, wherein the programmable drive boost circuit is an enable circuit and the drive circuit is connected to the enable circuit by a data bus.

6. An active matrix OLED display as claimed in claim 1, wherein the programmable drive boost circuit is a current copier.

7. An active matrix OLED display as claimed in claim 6, wherein the current copier is controllable as a variable current sink with a duty programmed enable signal.

8. An active matrix OLED display as claimed in claim 6, wherein the current copier is controllable by a most significant bit of a programmed data signal.

9. An active matrix OLED display as claimed in claim 1, wherein the programmable drive boost circuit and the drive circuit are located on the same substrate.

10. An active matrix OLED display as claimed in claim 9, wherein the substrate comprises an amorphous silicon (a-Si) backplane.

11. An active matrix OLED display as claimed in claim 1, wherein the programmable drive boost circuit is a programmable current boost circuit.

12. An active matrix OLED display as claimed in claim 1, wherein the programmable drive boost circuit is a programmable voltage boost circuit.

13. A method of programming an active matrix organic light-emitting diode (OLED) display, the OLED display having a current programmed data line, a plurality of pixel circuits connected to the data line, a driver circuit connected towards one end of the data line to write display data to the pixels, and a programmable drive boost circuit connected towards another end of the data line from the drive circuit; the method comprising a first addressing period including programming the programmable drive boost circuit with a first current; and a second addressing period including writing display data to the pixels and supplying the first current to the data line.

14. A method as claimed in claim 13, including activating the programmable drive boost circuit with an enable data bit and one or more program data bits to provide a current biased with respect to the current provided to the data line from the drive circuit.

15. A method as claimed in claim 14, including enabling the programmable drive boost circuit for a fixed time period.

16. A method as claimed in claim 14, including enabling the programmable drive boost circuit and providing a current corresponding to the most significant bit of the digital signal information transmitted by the driver circuit.

17. A method as claimed in claim 14, including programming the programmable booster circuit to vary according to a duty cycle.

18. A method as claimed in claim 13, wherein the display comprises a flat panel display.

19. A method as claimed in claim 13, wherein the display comprises a top-emitting active matrix OLED display.

20. (canceled)

21. (canceled)
